(19) United States
(12) Patent Application Publication
(10) Pub. No.: US 2015/0300536 A1
(43) Pub. Date: Oct. 22, 2015

(54) THREADED PIPE HAVING PROTECTIVE COATING

(71) Applicant: BAYOU PERMA-PIPE CANADA, LTD., Camrose (CA)

(72) Inventors: Randy Zilli, Camrose (CA); Don Bjorkman, Camrose (CA); John Langkamp, Camrose (CA); Kael Crichton, Camrose (CA)

(21) Appl. No.: 14/689,897

(22) Filed: Apr. 17, 2015

Related U.S. Application Data
(60) Provisional application No. 61/981,478, filed on Apr. 18, 2014.

(51) Int. Cl. F16L 9/14; F16L 15/00; B05D 3/00

(52) U.S. Cl. CPC F16L 9/14; B05D 3/007; F16L 15/00

(57) ABSTRACT

Coated threaded pipe and methods for manufacturing same. The coating may be fusion bonded epoxy coating. Threaded end portions of the pipes are protected from fouling and damage. The coating is applied to intermediate portions of the pipes between the threaded end portions. Connectors may be used for connecting ends of adjacent pipes in a continuous coating process and protecting the threaded end portions.

### TECHNICAL FIELD

The present disclosure generally relates to pipes. More specifically, the present disclosure relates to threaded pipe having a protective external coating and associated methods.

### BACKGROUND

Threaded pipe is used for many purposes, such as for casing pipe in a drilled well. Before use of threaded pipe in the field, it may be desirable to coat the threaded pipe for reasons such as abrasion protection, slip resistance, and/or corrosion protection. Coating threaded pipe presents the challenge of protecting threads on the pipe from damage during the coating process.

### SUMMARY

In one aspect, the present invention is directed to apparatus including a pipe having opposite first and second open ends and a hollow interior extending between the first and second open ends. The pipe includes opposite first and second end portions adjacent the respective first and second open ends. The first and second end portions are externally threaded. The pipe includes an intermediate portion extending between the first and second end portions and having an exterior. A fusion bond epoxy coating overlies the exterior of the intermediate portion. The first and second end portions are substantially free of fusion bond epoxy coating.

In another aspect, the present invention is directed to apparatus including a first pipe having opposite first and second open ends and a hollow interior extending between the first and second open ends. The first pipe includes opposite first and second end portions adjacent the respective first and second open ends. The first and second end portions are externally threaded. The first pipe includes an intermediate portion extending between the first and second end portions and having an exterior. A coating overlies the exterior of the intermediate portion of the first pipe. A second pipe has opposite first and second open ends and a hollow interior extending between the first and second open ends. The second pipe includes opposite first and second end portions adjacent the respective first and second open ends. The first and second end portions are externally threaded. The second pipe includes an intermediate portion extending between the first and second end portions and having an exterior. A coating overlies the exterior of the intermediate portion of the second pipe. A first receiver has the first end portion of the first pipe body received therein for protecting the first end portion. A second receiver has the second end portion of the first pipe body received therein for protecting the second end portion. The coating overlying the exterior of the intermediate portion of the second pipe includes a powder liquefied over the exterior of the intermediate portion and not yet hardened.

In yet another aspect, the present invention is directed to a method of applying a fusion bond epoxy coating on a plurality of threaded pipes. Each pipe has opposite first and second open ends and a hollow interior extending between the first and second open ends. Each pipe includes opposite first and second end portions adjacent the respective first and second open ends. The first and second end portions are externally threaded. The pipes each include an intermediate portion extending between the first and second end portions. A protective covering is positioned over the end portions of the pipes. The pipes are heated. A powder is applied over the intermediate portions of the pipes and not on the end portions for forming a coating on the intermediate portions.

Other objects and features of the present invention will be in part apparent and in part pointed out herein.

### BRIEF DESCRIPTION OF THE DRAWINGS

FIG. 1 is a side elevation of a pipe having threaded end portions;

FIG. 2 is a flow diagram illustrating method steps of the present invention;

FIG. 3 is a vertical section of a connector of the present invention;

FIG. 4 is a fragmentary side elevation of a pipe of the present invention having the connector (shown in vertical section) mounted on a first end and a shield layer overlying a second end;

FIG. 5 is a fragmentary side elevation of pipes connected end-to-end by connectors shown in vertical section for traversing a coating line;

FIG. 6 is a fragmentary side elevation of the pipe, connector (shown in vertical section), and shield layer of FIG. 4 having a coating thereon;

FIG. 7 is a side elevation of the pipe of FIG. 6 having the connector and shield layer removed, revealing uncoated threaded end portions of the pipe;

FIG. 8 is a fragmentary side elevation of pipes connected end-to-end by connectors shown in vertical section of a second embodiment of the present invention for traversing a coating line;

FIG. 9 is a fragmentary side elevation of a pipe and connector (shown in vertical section) of FIG. 8 with a coating on the pipe;

FIG. 10 is a fragmentary side elevation of pipes connected end-to-end by connectors shown in vertical section of a third embodiment of the present invention for traversing a coating line;

FIG. 11 is a fragmentary side elevation of a pipe and connector (shown in section) of FIG. 10 with a coating on the pipe;

FIG. 12 is a fragmentary side elevation of pipes connected end-to-end by connectors shown in vertical section of a fourth embodiment of the present invention for traversing a coating line; and

FIG. 13 is a fragmentary side elevation of a pipe and connector (shown in vertical section) of FIG. 12 with a coating on the pipe.

Corresponding reference characters indicate corresponding parts throughout the drawings.

### DETAILED DESCRIPTION

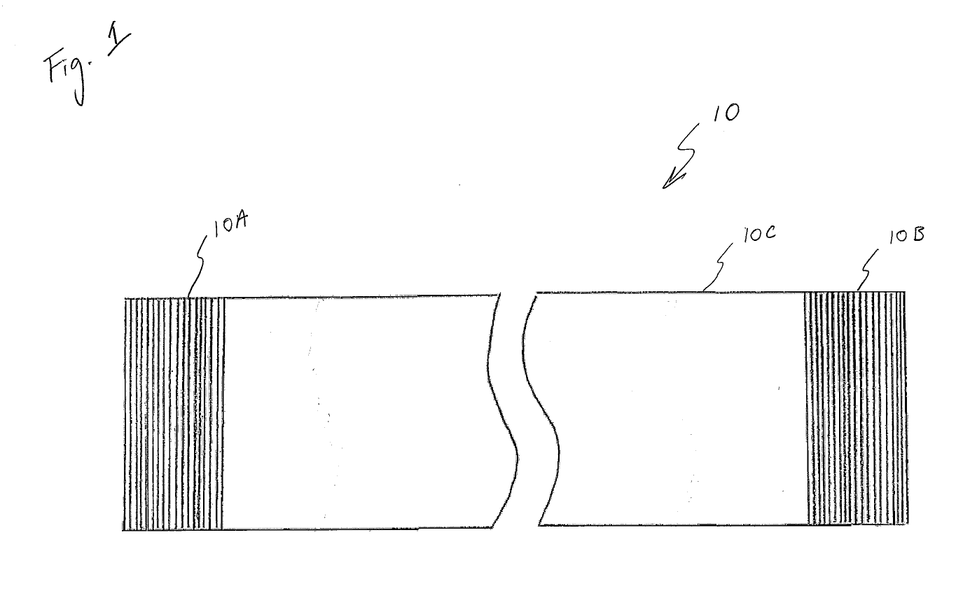

Threaded pipe is used for various purposes, and in many cases it may be desirable to coat the threaded pipe, depending on the environment in which the threaded pipe will be used. Referring to FIG. 1, an example threaded pipe, generally indicated by the reference number 10, includes opposite externally threaded end portions 10A, 10B and an intermediate non-threaded portion 10C extending between the threaded end portions. It will be understood that the pipe 10 is tubular and has a hollow interior extending from one open end of the pipe to the other. For example without limitation, such threaded pipe may be installed in wells to serve as casing for the bore holes forming the wells, in which case it may be referred to as “casing pipe.” In use, several of the pipes may be connected together using the threaded end portions to form a length of casing pipe suitable for a given circumstance. It will be understood the threaded pipe 10 may be used for other purposes than casing pipe without departing from the scope of the present invention.

It may be desirable to apply coating to the pipe 10 to provide benefits such as abrasion resistance, slip resistance, grip enhancement, and corrosion protection. The coating may also reduce or eliminate the need for cathodic protection. The threaded pipe 10 may be made of steel or another type of metal. It is known to coat threaded pipe in the field before installing it as casing pipe in a bore hole. In the field, the coating process (e.g., blast cleaning and application of coating) is carried out one pipe at a time. The pipe is heated to a relatively low elevated temperature, and a liquid epoxy is applied, which forms into a coating on the pipe. The field-applied coating is beneficial, but is not as good as plant-applied coating.

In one aspect, the present invention provides a method of coating threaded pipe in a continuous fashion in a plant setting. In one example, a fusion bond epoxy coating is applied. The threaded end portions of the pipe are shielded during the coating process so the threads on the pipe are protected from burning, denting, scratching, and other types of damage. As will become apparent, the method provides a superior coated pipe compared to pipes coated using the liquid epoxy method explained above.

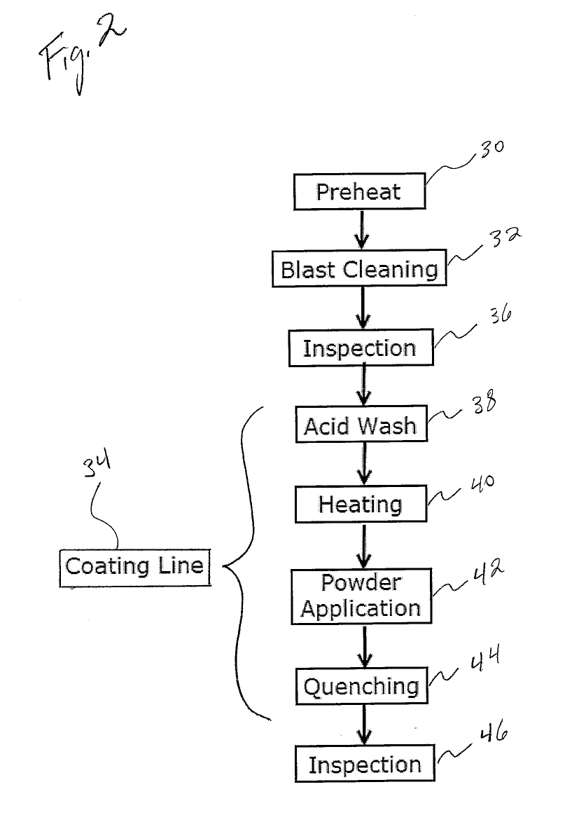

Referring to FIG. 2, an example pipe preparation and coating method according to the present invention includes several steps. It will be understood that more, fewer, and/or other steps may be used without departing from the scope of the present invention. The first two steps include preheating 30 and blast cleaning 32. In these two steps, pipes may be run along a conveyor in end-to-end fashion. The conveyor moves the pipes through a heater (e.g., natural gas heater) for warming the pipes (e.g., to at least 3° C. above dew point). Next, the conveyor moves the pipes through a blaster for preparing the outer surface of the pipe for coating. After blast cleaning, the pipes are received on a holding rack where they may be inspected. Suitable conveyors, heaters, and blast cleaning methods are known in the industry.

Referring still to FIG. 2, the pipes are then moved along a “coating line” 34 in which a conveyor moves the pipes in end-to-end fashion through various stages for coating the pipe. The coating line may include an acid wash step 38, a heating step 40, a powder application step 42, and finally a quenching step 44. Optionally, the pipes may be heated (e.g., to 40-50° C.) before the acid wash step. The acid wash step 38 may include spraying the pipes with a phosphorous acid, which is then rinsed from the pipes by high pressure spray of deionized water. In the heating step 40, the pipes are heated by natural gas ovens and/or induction heating to a high temperature, such as at least about 240° C. (or at least about 200° C.). After the heating step 40, fusion bond epoxy powder is applied to the pipes in a powder application step 42. For example, the powder may be electrostatically applied to the pipes. In response to the high heat of the pipes, the powder liquefies, gels, and then hardens, forming a fusion bond epoxy coating on the exterior surface of the pipes. Multiple layers of fusion bond epoxy (e.g., 2, 3, 4, or more layers) may be formed by applying sequential layers of powder. In the quenching step 44, the coated pipes are run through a water bath to cool the pipes. A final inspection step 46 may then be performed on the pipes, which may include holiday detection, or detection of discontinuities in the fusion bond epoxy coating. It will be understood that the fusion bond epoxy coating is provided by example without limitation. Other coatings may be applied without departing from the scope of the present invention.

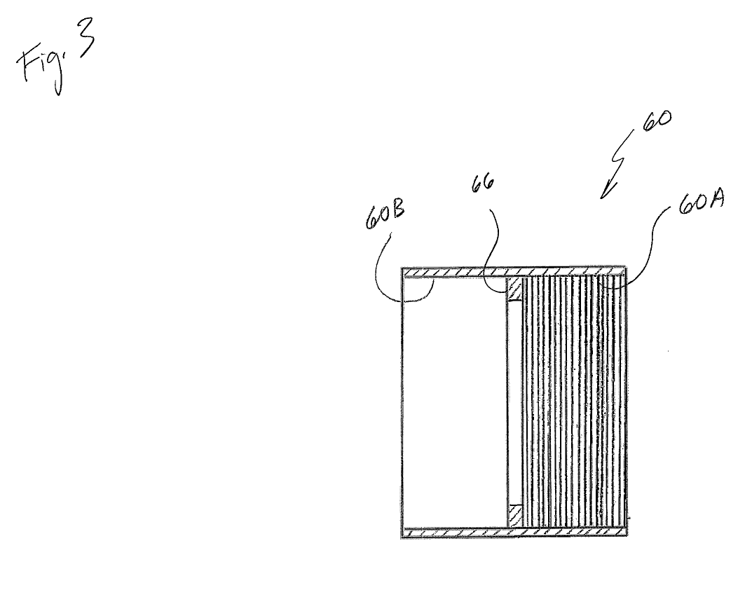

In an aspect of the present invention, various measures may be taken to protect the threaded end portions 10A, 10B of the pipes 10 on the coating line 34, or during the coating process. For example, before the pipes 10 are moved onto the coating line conveyor, the pipes may be stationed on a holding rack upstream from the coating line. As shown in FIGS. 3-7, in a first embodiment, the threaded end portions 10A, 10B may be protected using high temperature tape 50 (broadly “shield layer”) and connectors 60 (which may also be referred to as “come-alongs”).

As shown in FIG. 3, the connector 60 has a generally tubular body and includes opposite first and second receivers 60A, 60B for receiving threaded ends of respective pipes 10. The connector 60 may be formed of a metal (e.g., steel) suitable for withstanding the high temperatures of the coating line. Each receiver 60A, 60B defines a generally cylindrical cavity having a width (diameter) and length sized for receiving substantially the entire threaded end portion 10A, 10B of a pipe 10. The first receiver 60A includes threads configured to threadably engage the threads on the threaded end portion 10A, 10B of a pipe 10. The second receiver 60B is generally smooth-walled, not having threads. A spacer 66 separates the first receiver 60A from the second receiver 60B for preventing ends of pipes in the receivers from contacting each other. The illustrated spacer 66 is a ring protruding radially inward from and welded to the interior surface of the tubular body of the connector 60. Other spacers may be used, and the spacer may be omitted, without departing from the scope of the present invention.

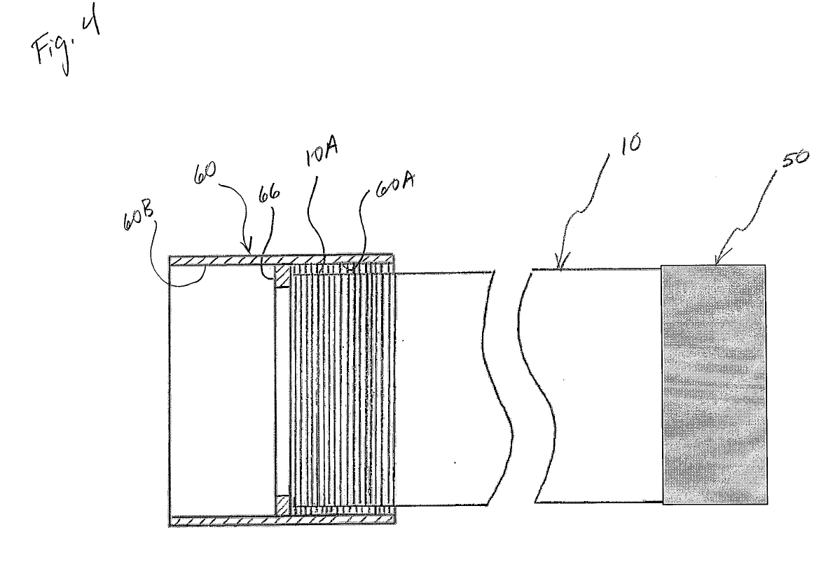

Referring to FIG. 4, to prepare a pipe 10 for the coating line, a connector 60 may be mounted on a first threaded end portion of the pipe, and high temperature tape 50 may be wrapped around the opposite, second threaded end portion. The connector 60 is mounted on the pipe by threadably connecting the first receiver 60A to the first threaded end portion 10A of the pipe 10. The receiver 60A is advanced over the threaded end portion 10A until the connector 60 covers substantially the entire threaded end portion. It will be understood that in FIG. 4 the width of the threaded receiver 60A is exaggerated for purposes of clarity of illustration, as is also the case in other Figures. The high temperature tape 50 may be applied to the second threaded end portion 10B by adhering a first end of the tape to the end portion and wrapping the tape around the end portion a sufficient number of times to cover substantially all of the threads of the second threaded end portion. Other tapes may be used without departing from the scope of the present invention. It will be understood that the high temperature tape 50 is suited for withstanding the high temperatures applied to the pipes on the coating line (i.e., without burning or melting). The tape 50 may also be referred to as heat resistant tape. Moreover, the tape 50 may be referred to broadly as a shield layer overlying the threaded end portion 10B of the pipe 10. Other shield layers (e.g., non-adhesive tape or rings or annular bands) may be used without departing from the scope of the present invention.

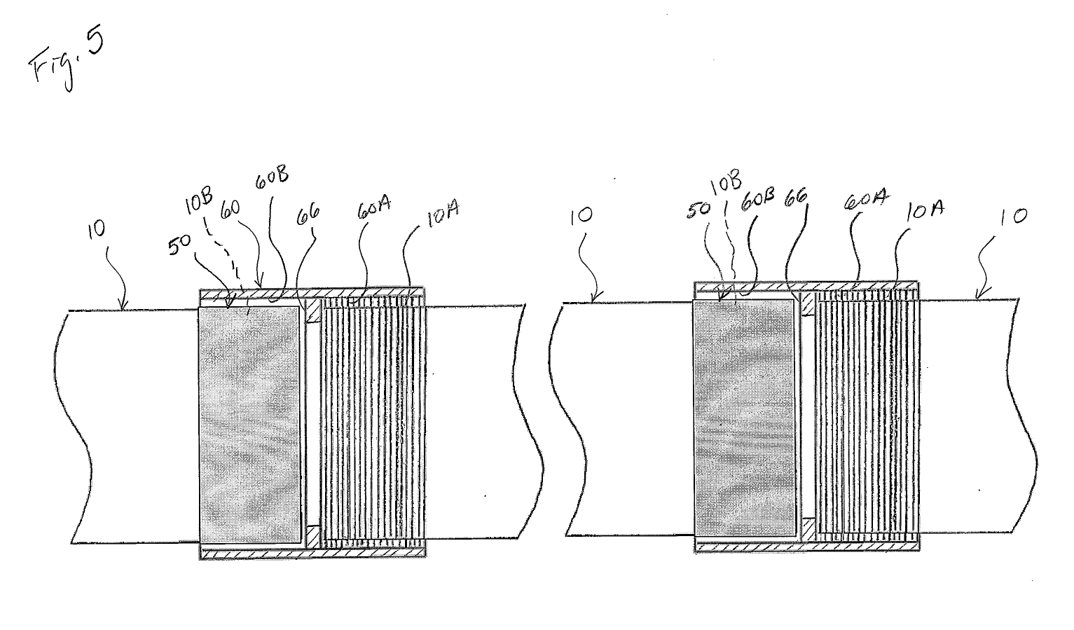

After pipes 10 are prepared in the fashion shown in FIG. 4, they are ready for the coating line 34. Referring to FIG. 5, three pipes 10 are shown in end-to-end fashion as they would be positioned on the conveyor of the coating line. As a pipe 10 is fed onto the conveyor, the threaded end portion 10B having the tape is positioned on the upstream end of the pipe (to the right in FIG. 5), and the threaded end portion 10A having the connector 60 is positioned on the downstream end of the pipe (to the left in FIG. 5). The orientation of the pipes 10 can be reversed without departing from the scope of the present invention. The conveyor includes an initial section that moves the pipes 10 relatively quickly, which moves the taped end of a pipe 10B into the smooth walled receiver 60B of the connector 60 mounted on the preceding pipe on the conveyor. Accordingly, as the pipes 10 are loaded onto the conveyor, they are connected together in end-to-end fashion by the connectors 60, as shown in FIG. 5. Desirably, substantially all of a threaded end portion 10B having the tape 50 is received into the non-threaded receiver 60B of the connector 60 on the preceding pipe. The tape 50 protects the threads from damage (e.g., scratching or denting) as they pass into the non-threaded receiver 60B. When the taped threaded end portion 10B is received in the non-threaded receiver 60B, the tape 50 may be referred to broadly as a shield layer overlying the threaded end portion inside the receiver. As with the threaded receivers 60A, the non-threaded receivers 60B are shown in the Figures as having exaggerated widths for purposes of clarity of illustration. The non-threaded receivers 60B may have a smaller width in practice. However, it should be noted that the connector 60 may not actually “join” the pipes together in the sense that the connector resists axial force tending to pull the pipes apart. The connector 60 may merely serve to overlie the threaded end portions 10A, 10B in the receivers 60A, 60B and maintain those threaded end portions in register with one another for moving along the conveyor.

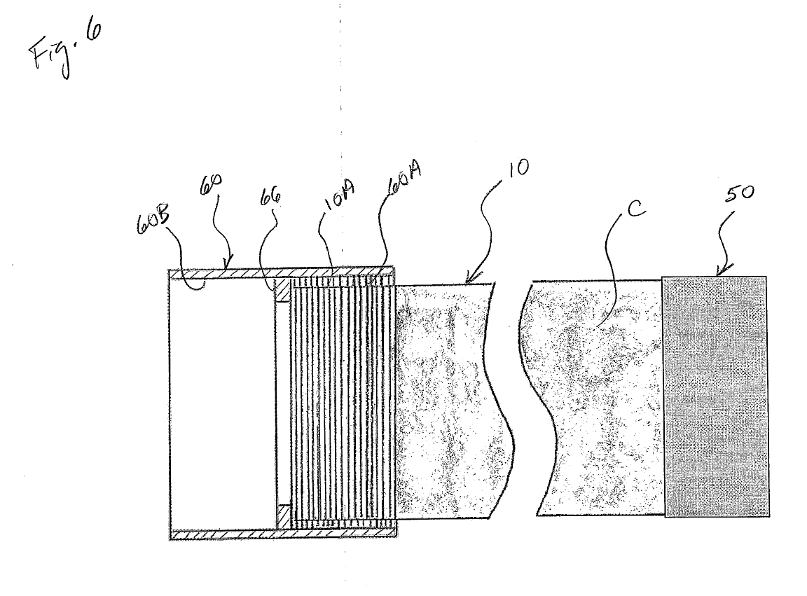

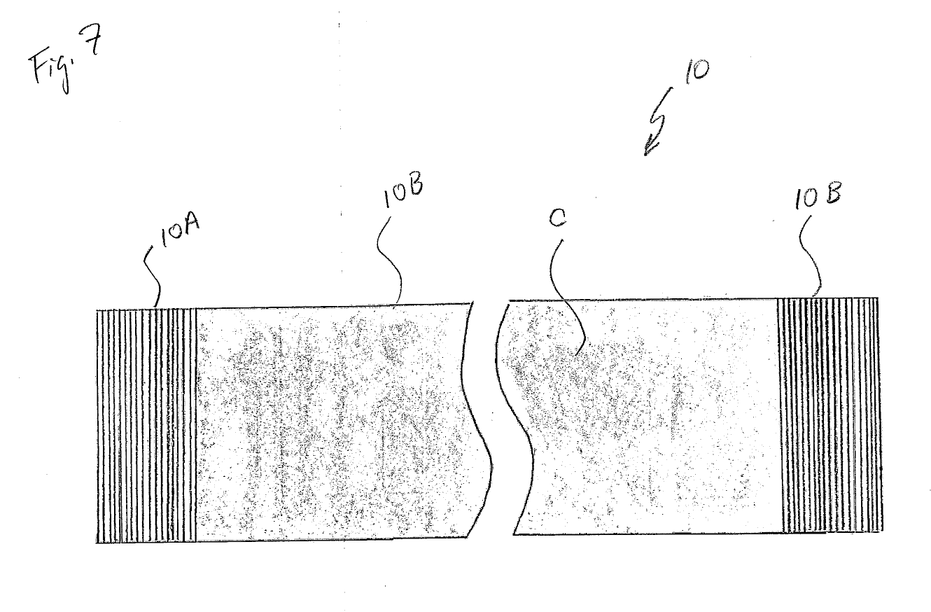

When the pipes 10 are connected in the fashion shown in FIG. 5, the threaded end portions 10A, 10B will be protected from damage as the pipes are moved through the various steps of the coating line. At the end of the conveyor, the speed of movement of the pipes 10 is increased so that the pipes are separated from one another. The taped threaded end portions 10B of the pipes are removed from the connectors 60 as the speed of movement of the conveyor increases adjacent its end. The result is a plurality of separate pipes 10 like the pipe shown in FIG. 6, each having a coating C (e.g., fusion bond epoxy coating), a connector 60 on one threaded end portion 10A, and high temperature tape 50 on the other threaded end portion 10B. The plurality of pipes 10 are moved to a rack on which the connectors 60 and tape 50 can be removed, leaving a coated pipe 10, as shown in FIG. 7, having undamaged and uncoated threaded end portions 10A, 10B.

It will be appreciated that coated threaded pipes according to the present invention have several benefits over threaded pipes that are coated in the field as described above. Pipes coated according to the present invention can be made cheaper, faster, and more efficiently than the field-coated pipes. Because a system has been developed to protect the threaded end portions of threaded pipe in the continuous coating process in a plant, all of the benefits of plant-applied coating can be realized. For example, the pipes can be heated to a significantly higher temperature than in the field, which permits the application of powder epoxy (as opposed to liquid epoxy) for producing fusion bonded epoxy coating, which provides superior abrasion resistance, coating adhesion, and corrosion protection than traditional field-applied coatings. Moreover, the pipes are coated mechanically on the plant coating line rather than by hand in the field, resulting in a more consistent coating having greater quality control. Accordingly, coated threaded pipes according to the present invention can be made at a faster rate, reduced cost, and higher quality than threaded pipe coated in the field.

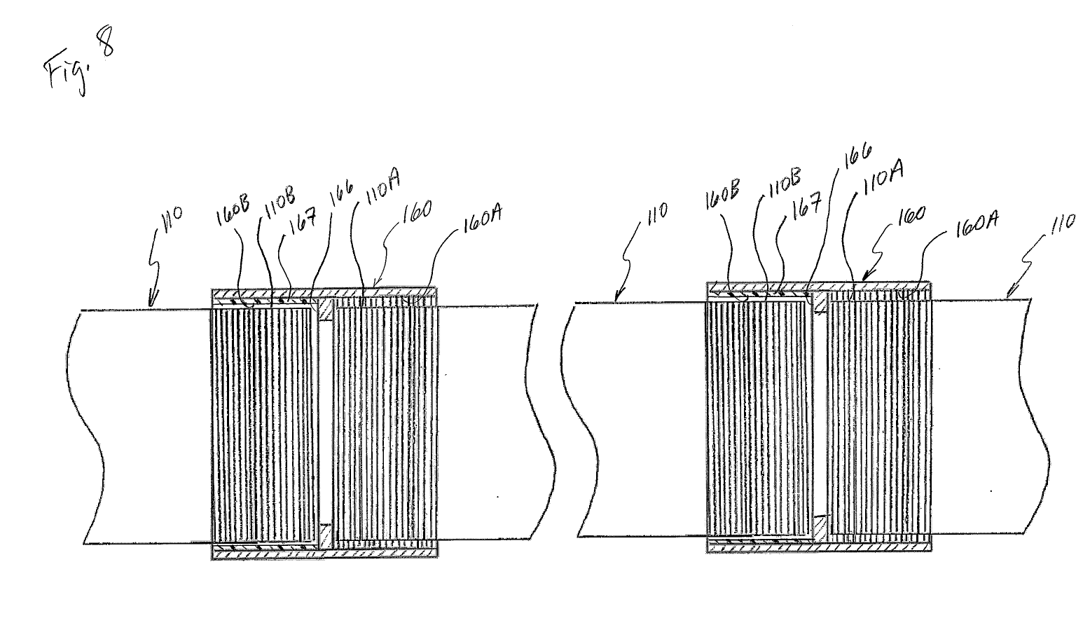

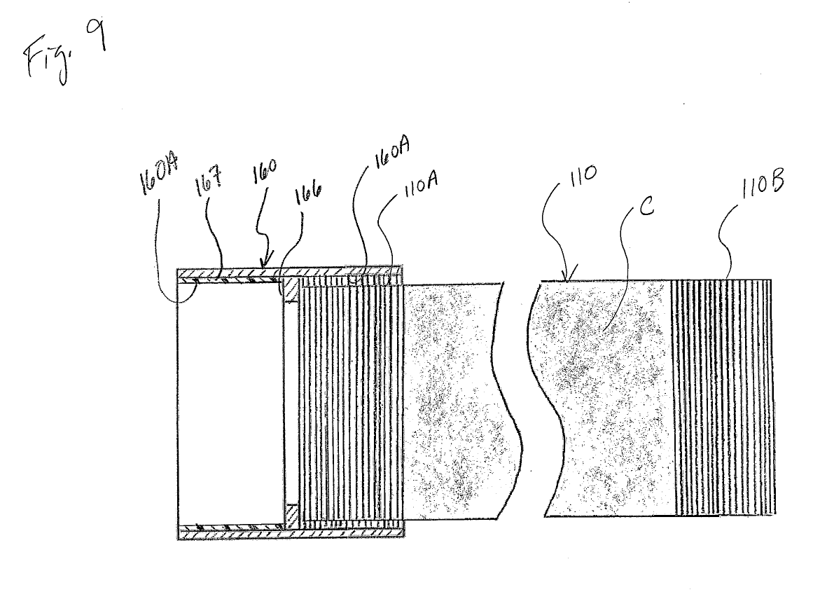

Referring to FIGS. 8 and 9, a second embodiment is shown in which like parts are designated by like reference numbers, plus 100. In this embodiment, the connector 160 includes a threaded receiver 160A for receiving the threaded end portion 110A like the connector 60 in the first embodiment. The connector 160 also includes a non-threaded receiver 160B, and a spacer 166 between the receivers. In this embodiment, the non-threaded receiver 160B includes a shield layer 167 inside the receiver. For example, the shield layer 167 may be bonded or adhered to the inside surface of the tubular connector body and extend around the circumference of the receiver 160B. The shield layer 167 may be formed of a different material than the body of the connector 160. Desirably, the shield layer 167 is soft enough to not dent or scratch the threads of a threaded end portion 110B inserted into the receiver 160B, and the shield layer protects the threaded end portion from the conditions (e.g., high temperatures) encountered on the coating line. The shield layer 167 may be sized to closely conform to and/or frictionally engage the threaded end portion 110B in the receiver 160B. In this embodiment, the pipes 110 are prepared for the coating line much like in the first embodiment, except the high temperature tape does not need to be applied, although it could be used without departing from the scope of the present invention. The conveyor connects the pipes 110 together as shown in FIG. 8, in a similar fashion as described with respect to the first embodiment. When the pipes 110 are connected together, the shield layer 167 positioned inside the connector 160 overlies the threaded end portion 110B in the receiver 160B. At the end of the coating line, individual coated pipes 110 having a connector 160 at one end are removed from the conveyor. After the connector 160 is removed, the result is threaded pipe 110 having a coating C that would look similar to the pipe shown in FIG. 7, having uncoated and undamaged threaded end portions 110A, 110B.

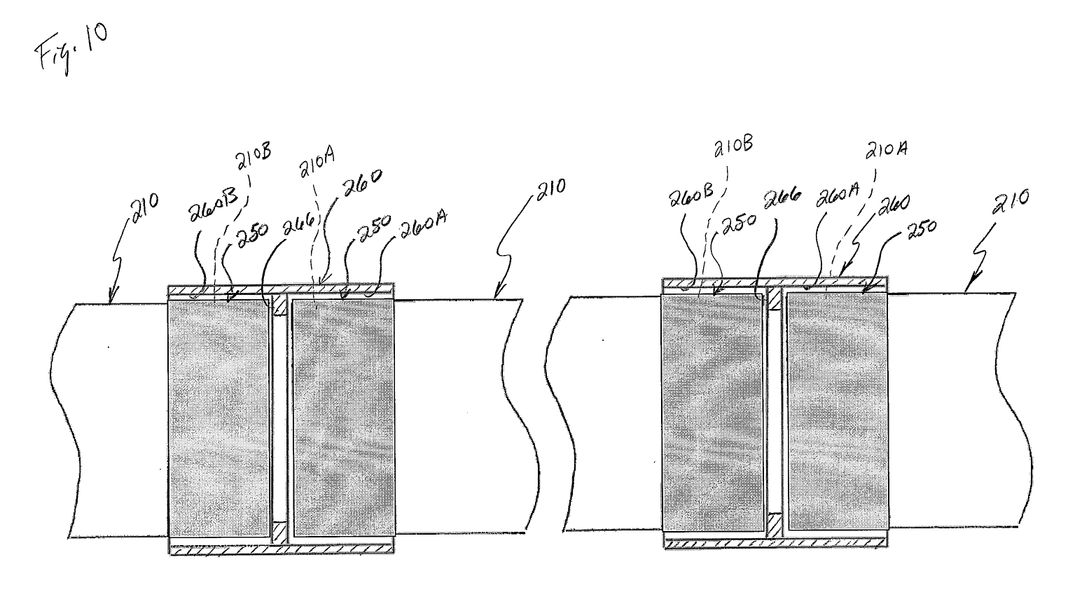

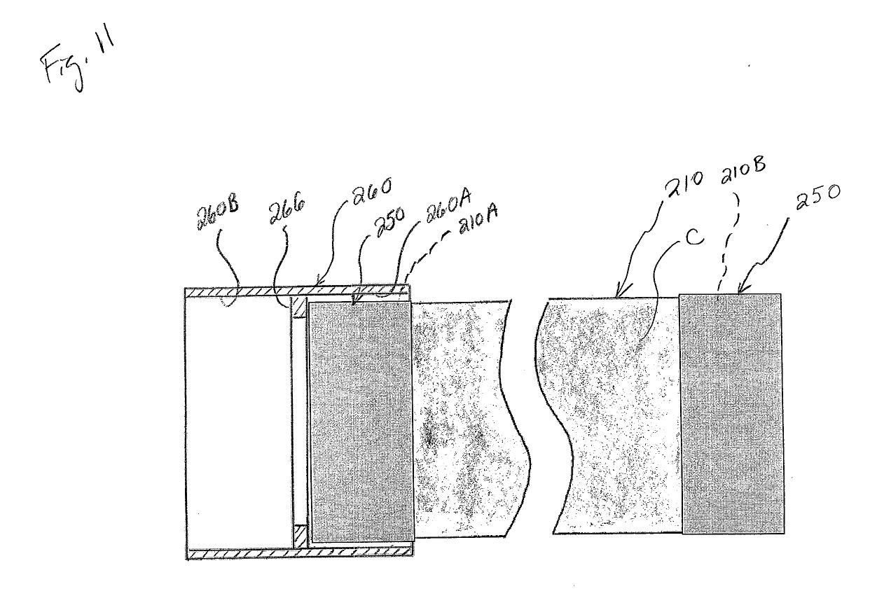

Referring to FIGS. 10 and 11, a third embodiment is shown in which like parts are designated by like reference numbers, plus 200. In this embodiment, the connector 260 does not include a threaded receiver like the connector 60 in the first embodiment. Instead, the connector 260 includes two receivers 260A, 260B having generally smooth walls. The receivers 260A, 260B are separated by a spacer 266. In this embodiment, both threaded end portions 210A, 210B of the pipe 210 are wrapped with high temperature tape 250 (shield layer). The pipes 210 can be prepared for the coating line by wrapping both end portions with the tape 250 and mounting a connector 260 over one of the threaded end portions 210A, 210B. When loaded on the conveyor, the pipes 210 are connected in end-to-end fashion as shown in FIG. 10 in a manner similar to that described above with respect to the first embodiment. One or both of the receivers 260A, 260B may be configured for friction fit with the taped threaded end portion 210A, 210B of one of the pipes to mount and retain the connector on the pipe 210. At the end of the coating line, the result is a plurality of threaded pipes 210 having a coating C, taped end portions 210A, 210B, and a connector 260 on one end, as shown in FIG. 11. Alternatively, the connector 260 may come free of the pipes 210 at the end of the conveyor. After removal of the connector 260 and the tape 250, the coated threaded pipe 210 would look similar to the pipe shown in FIG. 7, having uncoated and undamaged threaded end portions.

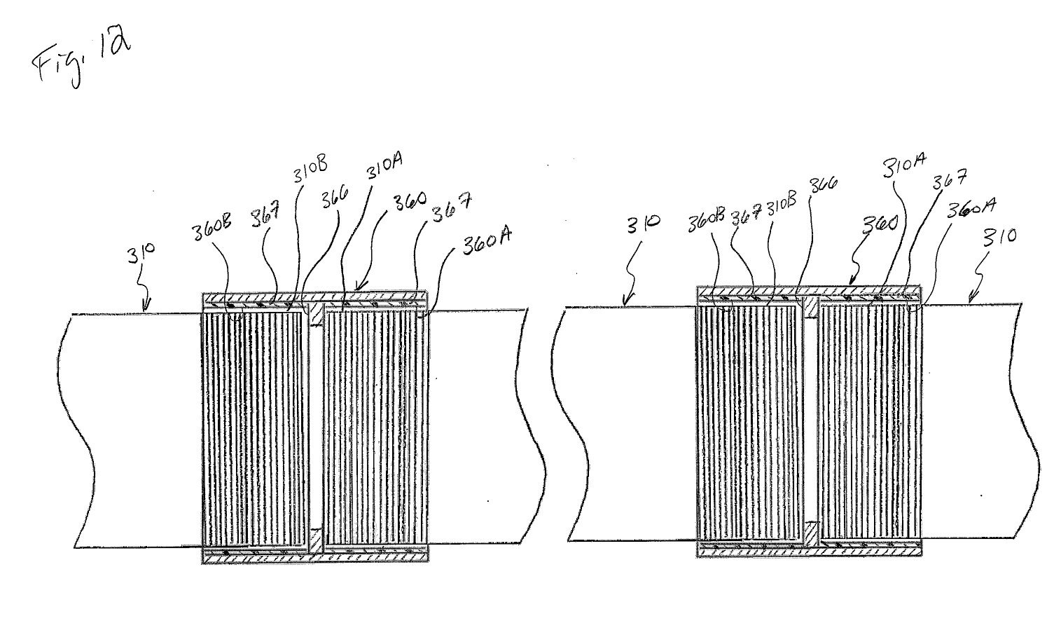

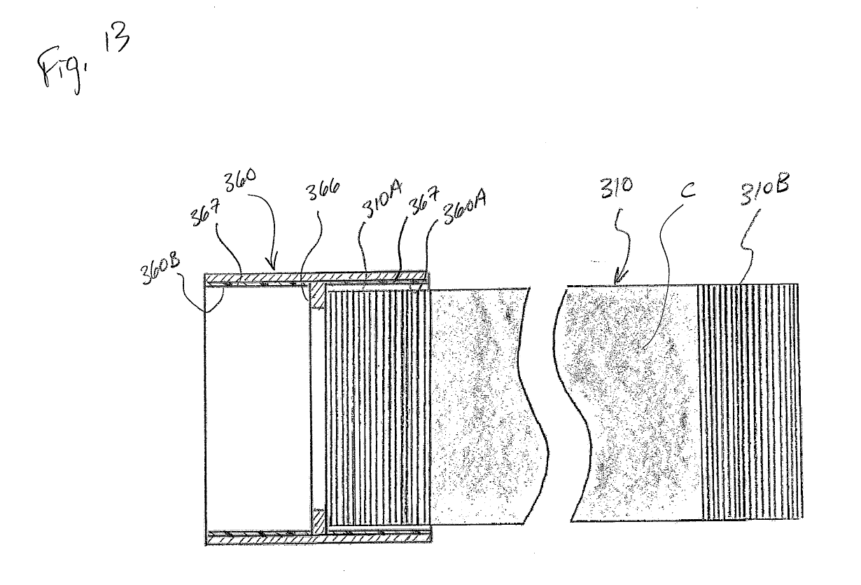

Referring to FIGS. 12 and 13, a fourth embodiment is shown in which like parts are designated by like reference numbers, plus 300. In this embodiment, the connector 360 includes two non-threaded receivers 360A, 360B including a shield layer 367. The shield layers 367 may be similar to and function similarly to the shield layer described above with respect to the second embodiment. The receivers 360A, 360B are separated by a spacer 366. The pipes 310 can be prepared for the coating line by mounting a connector 360 over one of the threaded end portions 310A, 310B. When loaded on the conveyor, the pipes 310 are connected in end-to-end fashion as shown in FIG. 12 in a manner similar to that described above with respect to the first embodiment. One or both of the receivers 360A, 360B may be configured for friction fit with the threaded end portion 310A, 310B of one of the pipes 310 to mount and retain the connector 360 on the pipe. At the end of the coating line, the result is a plurality of threaded pipes 310 having a coating C and a connector 360 on one end, as shown in FIG. 13. Alternatively, the connector 360 may come free of the pipes 310 at the end of the conveyor. After removal of the connector 360, the coated threaded pipe 310 would look similar to the pipe shown in FIG. 7, having uncoated and undamaged threaded end portions.

Having described the invention in detail, it will be apparent that modifications and variations are possible without departing from the scope of the invention defined in the appended claims.

As various changes could be made in the above constructions and methods without departing from the scope of the invention, it is intended that all matter contained in the above description and shown in the accompanying drawings shall be interpreted as illustrative and not in a limiting sense.

What is claimed is:

1. Apparatus comprising:
a pipe having opposite first and second open ends and a hollow interior extending between the first and second open ends, the pipe including opposite first and second end portions adjacent the respective first and second open ends, the first and second end portions being externally threaded, the pipe including an intermediate portion extending between the first and second end portions and having an exterior, and
a fusion bond epoxy coating overlying the exterior of the intermediate portion,
wherein the first and second end portions are substantially free of fusion bond epoxy coating.

2. Apparatus as set forth in claim 1 wherein the fusion bond epoxy coating extends around a full circumference of the intermediate portion and along substantially an entire length of the intermediate portion.

3. Apparatus as set forth in claim 1 further comprising a heat shield layer overlying the first end portion.

4. Apparatus as set forth in claim 3 wherein the heat shield layer includes heat resistant tape.

5. Apparatus as set forth in claim 3 further comprising a connector threaded on the second end portion.

6. Apparatus as set forth in claim 3 further comprising a receiver overlying the heat shield layer and the first end portion.

7. Apparatus as set forth in claim 6 wherein the receiver has a non-threaded interior surface.

8. Apparatus as set forth in claim 3 further comprising a receiver overlying the first end portion, the heat shield layer being mounted on the receiver.

9. Apparatus as set forth in claim 1 wherein the pipe is a first pipe and the apparatus further comprises:
a second pipe having opposite first and second open ends and a hollow interior extending between the first and second open ends, the second pipe including opposite first and second end portions adjacent the respective first and second open ends, the first and second end portions being externally threaded, the second pipe including an intermediate portion extending between the first and second end portions and having an exterior,
a fusion bond epoxy coating overlying the exterior of the intermediate portion of the second pipe, and
a connector including opposite first and second receivers, the first end portion of the first pipe being received in the first receiver, the second end of the second pipe being received in the second receiver.

10. Apparatus as set forth in claim 9 wherein the first receiver is threadably connected to the first end portion of the first pipe and the second receiver is not threadably connected to the second end of the second pipe.

11. Apparatus as set forth in claim 10 further comprising a shield layer overlying the second end portion of the second pipe and underlying the second receiver.

12. Apparatus as set forth in claim 9 further comprising a shield layer overlying the first end portion of the first pipe and underlying the first receiver and a shield layer overlying the second end portion of the second pipe and underlying the second receiver.

13. Apparatus as set forth in claim 1 wherein the coating comprises a powder liquefied over the exterior of the intermediate portion and not yet hardened.

14. Apparatus comprising:
a first pipe having opposite first and second open ends and a hollow interior extending between the first and second open ends, the first pipe including opposite first and second end portions adjacent the respective first and second open ends, the first and second end portions being externally threaded, the first pipe including an intermediate portion extending between the first and second end portions and having an exterior,
a coating overlying the exterior of the intermediate portion of the first pipe,
a second pipe having opposite first and second open ends and a hollow interior extending between the first and second open ends, the second pipe including opposite first and second end portions adjacent the respective first and second open ends, the first and second end portions being externally threaded, the second pipe including an intermediate portion extending between the first and second end portions and having an exterior,
a coating overlying the exterior of the intermediate portion of the second pipe,
a first receiver having the first end portion of the first pipe body received therein for protecting the first end portion, and
a second receiver having the second end portion of the first pipe body received therein for protecting the second end portion,
wherein the coating overlying the exterior of the intermediate portion of the second pipe comprises a powder liquefied over the exterior of the intermediate portion and not yet hardened.

15. Apparatus as set forth in claim 14 wherein the exterior of the intermediate portion of the second pipe has a temperature of at least 200 degrees Celsius.

16. Apparatus as set forth in claim 14 wherein the first and second receivers are on opposite ends of a connector.

17. A method of applying a fusion bond epoxy coating on a plurality of threaded pipes, the method comprising:
providing a plurality of pipes, each pipe having opposite first and second open ends and a hollow interior extending between the first and second open ends, each pipe including opposite first and second end portions adjacent the respective first and second open ends, the first and second end portions being externally threaded, the pipes each including an intermediate portion extending between the first and second end portions,
positioning protective covering over the end portions of the pipes,
heating the pipes, and
applying a powder over the intermediate portions of the pipes and not on the end portions for forming a coating on the intermediate portions.

18. A method as set forth in claim 17 wherein heating the pipes comprises heating the intermediate portions to at least 200 degrees Celsius.

19. A method as set forth in claim 17 wherein positioning the protective covering over the end portions comprises receiving the first end portion of a first pipe into a first receiver of a connector and receiving the second end portion of a second pipe into a second receiver of the connector.

20. A method as set forth in claim 19 wherein receiving the first end portion of the first pipe into the first receiver comprises threadably connecting the first end portion to the first receiver, and wherein the second end portion of the second pipe is received in the second receiver without threadably connecting the second end portion to the second receiver.
